(19) United States
(12) Patent Application Publication
(10) Pub. No.: US 2003/0118017 A1
(43) Pub. Date: Jun. 26, 2003

(54) Method for assigning transmitting grants

(75) Inventors: Stefan Wahl, Schwieberdingen (DE); Ralf Klotsche, Neuenburg (DE)

Correspondence Address: SUGHRUE MION, PLLC, 2100 Pennsylvania Avenue, NW, Washington, DC, 20037-3213, US

(73) Assignee: ALCATEL

(21) Appl. No.: 10/303,798

(22) Filed: Nov. 26, 2002

(30) Foreign Application Priority Data
Nov. 30, 2001 (DE) 10158669.8

(51) Int. Cl. H04L 12/56; H04L 12/28

(52) U.S. Cl. 370/389

(57) ABSTRACT

A method for assigning transmitting grants to terminals of a communications network serving the bi-directional transfer of packet-orientated data with a management system and a central station is cited. In the central station there is an access control unit regulating the data traffic from the terminals to the central station, to which access control unit information on data ready for transmitting transmitted by the terminals is fed and by which transmitting grants are transferred to the terminals according to a defined, standardised protocol. For a generally valid method irrespective of the type of communications network the access control unit is equipped with a first adaptation module, a processor and a second adaptation module. The information from the terminals is fed to the first adaptation module. This feeds to the processor identifiers of the individual terminals and the number of bits or bytes reported as ready for transmitting.

### BACKGROUND OF THE INVENTION

The invention is based on a priority application DE 10158669.8 which is hereby incorporated by reference.

### SUMMARY OF THE INVENTION

The invention relates to a method for assigning transmitting grants to terminals of a communications network serving the bi-directional transfer of packet-orientated data, with a management system and a central station in which there is an access control unit regulating the data traffic from the terminals to the central station, to which access control unit information on data ready for transmitting is fed and by which transmitting grants are transferred to the terminals according to a defined, standardised protocol.

A method of this kind is standardised worldwide today for the most varied structures of communications networks—hereinafter called “networks” for short. The data traffic in networks of this kind operating with bi-directional transfer of data packets is regulated according to likewise standardised protocols, for example according to the Medium Access Control (MAC) protocol considered below. The networks also include standardised management systems in which the topology of the respective network is stored. A network constructed according to the so-called multiple access system is, for example, a point-to-multipoint network, also designated as subscriber access network—hereinafter called “access network” for short. An access network can be a radio network, such as LMDS (Local Multipoint Distribution System), for example, or a line-bound network, such as, for example, HFC (Hybrid Fibre Coax) on the basis of DVB (Digital Video Broadcast) or DOCSIS (Data Over Cable Service Interface Specification). In the access network there are terminals to which data packets going out from a central station are transferred and which can themselves transmit data packets to the central station. The invention relates to access networks of this kind in which the transfer medium with given bandwidth of the transfer channel has to be shared among all the terminals connected to the central station.

In order to enable undisturbed operation in the access network there is an access control unit in the central station, connected to the management system, hereinafter designated as “MAC” for short. The MAC uses the standardised MAC protocol to check the bandwidth of the transfer channel. The MAC is a layer in the so-called OSI (Open System Interconnection) model, which consists of seven layers. The first layer in the OSI model is the connection layer connected to the terminals. The MAC layer is the second layer. It conveys the packet-orientated data. Assignments of system resources are also controlled on the MAC layer. These are transmitting grants for the terminals, for example. In this way, for example, time slots, frequencies, codes, bandwidths or any combinations of these are assigned to the terminals as transmitting grants. The MAC layer is also responsible for functional security and quality and performance in the access network, as well as for maintaining service qualities of the valid protocol in each case. Assigning the transmitting grants is based on information the central station and therefore the MAC receives from the terminals.

In today's network technology a separate, matched MAC has to be developed and installed for every network structure, which cannot be used in another type of network.

The invention is based on designing the method initially depicted in such a way that it can be used irrespective of the respective type of network.

This object is achieved according to the invention in that

the access control unit is equipped with a first adaptation module, a processor and a second adaptation module,

the information from the terminals is fed to the first adaptation module,

the first adaptation module feeds to the processor, irrespective of the kind of network, identifiers of the individual terminals and the number of bits or bytes reported by them as ready for transmitting,

the processor, operating with a general algorithm, feeds to the second adaptation module, taking into account at least the available bandwidth of the transfer channel and the required service quality, at least the number of bits or bytes to be transmitted by the individual terminals and their identifiers and

the second adaptation module transfers the appropriate transmitting grants to the terminals in the protocol matched to the respective network.

This method can be used irrespective of the type of network, as the processor present in the MAC operates according to a generally valid algorithm. It therefore needs no information on the respective type of network. A processor can in this case be an element to be represented by hardware or by software, for example a one or more chip implementation on a module. It is always only identifiers of terminals and the number of bits or bytes the individual terminals wish to transmit which are fed to the processor by the first adaptation module. For this purpose the first adaptation module receives from the terminals information on data packets or bytes to be transmitted in service-specific representation. It forwards said information to the processor. This is connected to the management system of the network. The processor, taking into account the data delivered to it by the management system and the bandwidth of the transfer channel known to it, forms, with a universal algorithm, generic transmitting grants, which are transferred by the second adaptation module to the terminals, this being in the valid MAC protocol in each case, matched to the associated type of network. A transmitting grant contains at least the identifiers of the terminals concerned and the number of bits or bytes assigned to the individual terminals.

For fair assignment of the transmitting grants and to ensure the quality of the transfer, additional information on the individual terminals, such as transmitting times and type of transfer, for example, can be fed to the processor by the management system of the network. Further additional information for the processor can relate to the respective state of the transfer medium. This can be of significance in particular with radio networks.

### BRIEF DESCRIPTION OF THE DRAWINGS

The method according to the invention is explained in embodiment examples using the drawings.

FIG. 1 shows in schematic illustration a usual structure of a communications network.

FIG. 2 shows, also in schematic illustration, an access network.

FIG. 3 shows an access control unit contained in a central station of the access network in the form of bars.

FIG. 4 shows a detail of an access control unit.

### DESCRIPTION OF THE INVENTION

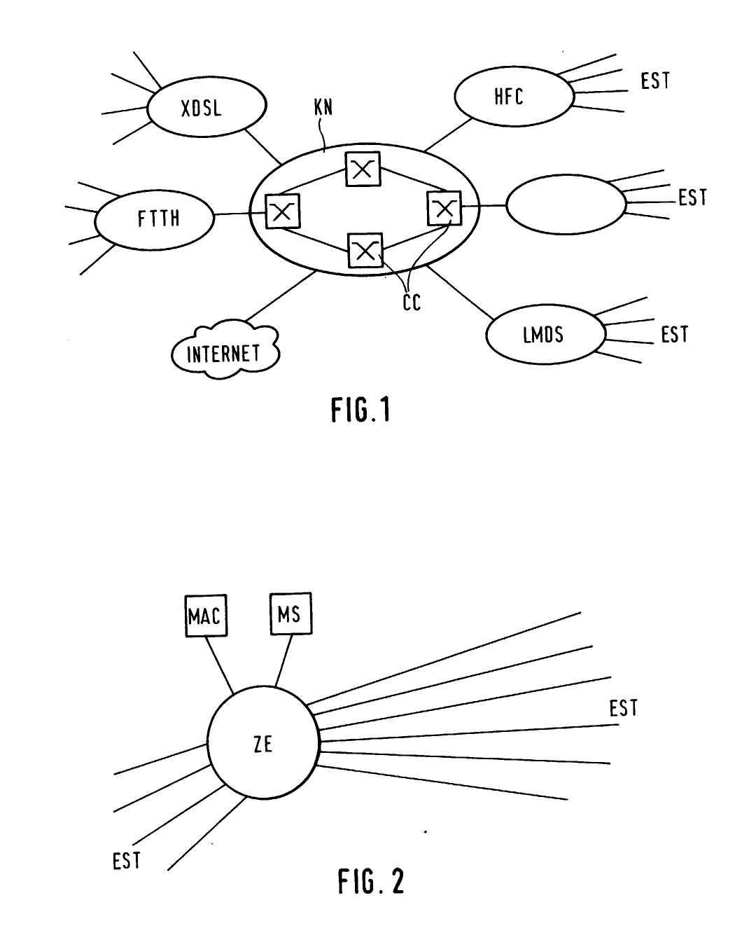

A usual communications network consists, according to FIG. 1, for example, of a core network KN, to which various partial networks are connected and can be connected to one another. There are suitable cross connectors CC in the core network KN for this purpose. Partial networks are, for example, digital subscriber networks XDSL, optical subscriber networks FTTH and the internet. Other partial networks in which the connected subscribers or terminals have to share a transfer channel with given bandwidth, are, for example, the two initially mentioned access networks HFC (line-bound) and LMDS (radio). The invention relates to access networks of this kind.

According to FIG. 2 an access network has a central station ZE, to which terminals EST are connected. An access control unit MAC and a management system MS are assigned to the ZE. The MAC checks the bandwidth of the transfer channel common to all the ESTs. It also assigns transmitting grants. The topology of the access network is stored in the MS.

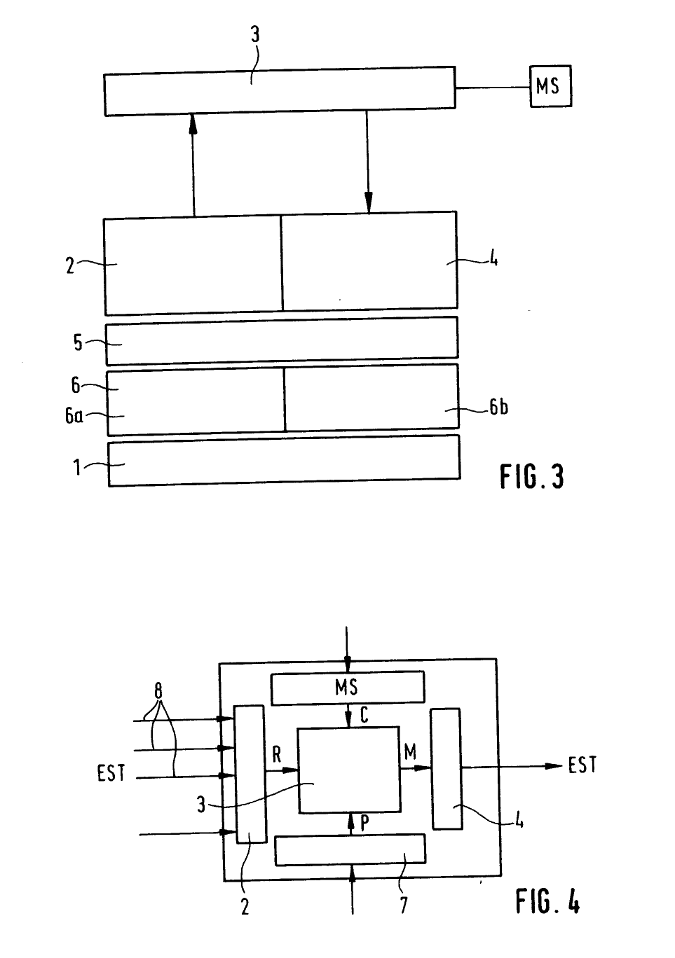

The access network can be the radio network LMDS, for example. For assigning transmitting grants the ESTs transmit, as requests to the ZE, the number of bits or bytes which are ready for transmitting and are to be transmitted. They arrive at the connection layer 1 of the MAC indicated in FIG. 3 and there are evaluated and edited according to the MAC protocol. Of the thus gained requests only the identifiers of the EST and the associated number of requested bytes are fed to a first adaptation module 2. This forwards the appropriate information to a processor 3, operating according to a general algorithm, and also connected to the MS. Taking into account the bandwidth known to it of the transfer channel common to all the ESTs of the LMDS and the topology of the access network supplied to it by the MS, the processor 3 forms generic transmitting grants, which it supplies to a second adaptation module 4. The transmitting grants are edited and listed in the MAC according to the MAC protocol. They contain at least the identifiers of the ESTs and the number of bytes assigned to the individual ESTs. The transmitting grants arrive at the connection layer 1 and are transferred from there to the ESTs.

Between the connection layer 1 and the adaptation modules 2 and 4 in FIG. 3 two further bars 5 and 6 are drawn in, representing electronic circuits or operating cycles. In bar 5 the information becoming available in each case is processed. It is examined for its correct format and with respect to addressing. Its content is extracted. Bar 6 is divided into two parts 6a and 6b. In part 6a the information arriving from the ESTs via the connection layer 1 is tested with all additional details (overhead) for correctness. This applies in the same way for part 6b in the outgoing transfer direction.

The depicted simplest case with which the number of bytes is assigned to the ESTs basically suffices for issuing transmitting grants. As, however, the processor 3 knows the topology of the entire access network and therefore also the quality of the different ESTs via the connected MS, further information can also be added to the transmitting grants. This is, for example, transmitting times, positions of time slots, type of modulation and code scheme. Different priorities of the individual ESTs can also be taken into account. Fair distribution of transmitting grants can therein always be assumed, so all ESTs wishing to transmit are taken into account at the appropriate time.

The same method cycle as was described using FIG. 3 for the radio network LMDS also applies to line-bound networks, for example the above-mentioned HFC on the basis of DVB. The incoming requests and the outgoing transmitting grants are edited analogously to the LMDS. Here too again only the identifiers and the number of bytes to be transmitted by the ESTs to the processor 3 are given by the first adaptation module 2. Here too generic transmitting grants with at least the identifiers and the number of bytes are fed by the processor 3 in accordance with bandwidth and information of the MS to the second adaptation module 4.

In FIG. 4 the processor 3 and the two adaptation modules 2 and 4 are illustrated in a different schematic assignment. From this can be seen a main direction of the information transfer, characterised by arrows R and M. Information from the MS is supplied to the processor 3 according to arrow C. Further information relating to the current physical state of the transfer medium can be fed to the processor 3 according to arrow P from a box 7. This information can be of particular significance in radio networks. In these the bandwidth of the transfer channel can soon be restricted by atmospheric influences, so an increase in the bit error rate may arise. This can also happen with line-bound transfer owing to mechanical external influences.

As well as the information mentioned in FIG. 3, further details can also be fed to the adaptation module 2 with the requests of the ESTs. These are, for example, information customary in transfer technology, such as “piggy backing”, “request message”, “poll me” and “slip indication”. These additional details are indicated in FIG. 4 by several arrows 8. They are intended to show that the appropriate requests come from the ESTs. The first adaptation module 2 converts this individual information and, after editing, forwards to the processor 3 only the identifier and number of bytes. Both adaptation modules 2 and 4 must translate at least the typical bandwidth requirements in the protocol applied into more abstract and generally valid requirements.

1. Method for assigning transmitting grants to terminals of a communications network serving the bi-directional transfer of packet-orientated data, with a management system and a central station in which there is an access control unit regulating the data traffic from the terminals to the central station, to which access control unit information on data ready for transmitting transmitted by the terminals is fed and by which transmitting grants are transferred to the terminals according to a defined, standardised protocol, wherein
the access control unit is equipped with a first adaptation module, a processor and a second adaptation module,
the information from the terminals is fed to the first adaptation module
the first adaptation module feeds to the processor identifiers of the individual terminals and the number of bits or bytes reported by them as ready for transmitting, irrespective of the type of communications network
the processor, operating with a general algorithm, feeds to the second adaptation module, taking into account at least the available bandwidth of the transfer channel and the required quality of service, at least the number of bits or bytes to be transmitted by the individual terminals and their identifiers and
the second adaptation module transfers the appropriate transmitting grants to the terminals in the protocol matched to the respective communications network.

2. Method according to claim 1, wherein additional information on the physical state of the transfer medium is fed to the processor.

3. Method according to claim 1, wherein the transmitting times and the type of transfer are also transferred to the terminals with the transmitting grants.
